(19) United States
(12) Patent Application Publication
(10) Pub. No.: US 2010/0295881 A1
(43) Pub. Date: Nov. 25, 2010

(54) METHOD FOR SIMULATING, FABRICATING, OR DUPLICATING AN OIL PAINTING

(75) Inventors: Being-Kung Yao, Taipei City (TW); Ailen Li, Taipei City (TW); Chih-Chieh Chen, Taipei City (TW); Mei-Hwei Chang, Hsin-Chu City (TW)

Correspondence Address: QUINTERO LAW OFFICE, PC, 615 Hampton Dr, Suite A202, Venice, CA, 90291, US

(73) Assignee: NATIONAL TAIWAN UNIVERSITY OF SCIENCE & TECHNOLOGY, TAIPEI CITY (TW)

(21) Appl. No.: 12/783,983

(22) Filed: May 20, 2010

(30) Foreign Application Priority Data
May 20, 2009 (TW) TW98116654

(51) Int. Cl. B41J 2/01

(52) U.S. Cl. 347/1

(57) ABSTRACT

A method for simulating, fabricating, or duplicating an oil painting is provided. The oil painting digital image information is acquired by scanning or capturing an oil painting surface image, and/or digitally simulating or rendering an oil painting surface image. A white paint is daubed on a base layer. A stereoscopic oil relief model, forming a stereoscopic oil relief layer, is acquired by topographically scanning the oil painting surface in three dimensions, and simulated or duplicated onto the base layer with a white or colorless transparent composite material. An image receiving layer is daubed on the stereoscopic oil relief layer. The oil image information, forming a printed oil painting surface image, is output and printed onto the image receiving layer with an inkjet printer. A transparent resin layer is daubed on the printed oil painting surface image, protecting the printed oil painting surface image with stereoscopic oil relief layer.

### CROSS REFERENCE TO RELATED APPLICATIONS

This Application claims priority of Taiwan Patent Application No. 98116654, filed on May 20, 2009, the entirety of which is incorporated by reference herein.

### BACKGROUND OF THE INVENTION

1. Field of the Invention

The invention relates to a method for simulating, fabricating, or duplicating an oil painting, and more particularly to a method that completely simulates, fabricates, or duplicates oil painting images with oil reliefs.

2. Description of the Related Art

Oil paintings play an important role in art and culture. High-quality artistic oil paintings are expensive and creations thereof require tremendous amount of time. Accordingly, the high-quality artistic oil paintings are rare in number and cannot be commonly viewed by the public. To allow the public to commonly view and appreciate the high-quality artistic oil paintings, replicas thereof are generated.

There are many conventional methods for simulating, fabricating, or duplicating a primitive oil painting. For example, a museum may commission a painter with a fine and delicate technique of drawing to directly redraw an oil painting by modeling the primitive oil painting. Nevertheless, this duplication method is time-consuming and difficult, such that a duplicated oil painting obtained thereby is provided at a high cost. Moreover, a replica of a primitive oil painting may be obtained by a photographic and printing method. However, the replica is only a flat picture with high definition and cannot provide stereoscopic oil reliefs of the primitive oil painting. Thus, to present the stereoscopic oil reliefs on the flat replica produced by the photographic and printing method, a three-dimensional surface is generated on the flat replica using a mechanical manner. Nevertheless, the three-dimensional surface generated by the mechanical manner cannot thoroughly present the original exquisite stereoscopic oil reliefs on the primitive oil painting. Furthermore, by another duplication method, stereoscopic and transparent coatings or equivalent oil paints may be added to the flat replica. Similarly, the duplicated oil painting produced by the other duplicating method cannot simultaneously present both the original exquisite stereoscopic oil reliefs and complex and delicate colors on the primitive oil painting.

Accordingly, the duplicated oil paintings produced by the conventional duplication methods cannot exactly combine complex image colors with stereoscopic oil reliefs of primitive oil painting. Thus, the resulting duplicated products cannot provide viewers a sense of real oil paintings when viewed up close.

Hence, there is a need for a method for simulating, fabricating, or duplicating an oil painting, to combine both high-definition images with respective stereoscopic oil reliefs.

### BRIEF SUMMARY OF THE INVENTION

A detailed description is given in the following embodiments with reference to the accompanying drawings.

An exemplary embodiment of the invention provides a method for simulating, fabricating, or duplicating an oil painting, comprising: scanning, capturing an oil painting surface image, or digitally simulating or rendering an image to acquire oil painting digital image information; topographically scanning, or simulating an oil painting surface in three dimensions to acquire a stereoscopic oil relief model; providing a base layer; duplicating or simulating the stereoscopic oil relief model onto the base layer with a white or colorless transparent composite material, forming a stereoscopic oil relief layer; daubing an image receiving layer on the stereoscopic oil relief layer; and outputting and printing the oil painting digital image information onto the image receiving layer with an inkjet printer, forming a printed oil painting surface image.

The method further comprises daubing a white paint on the base layer.

The method further comprises daubing a transparent resin layer on the printed oil painting surface image, protecting the printed oil painting surface image.

The white composite material comprises a first material and a second material.

The first material is selected from the group consisting of gypsum, clay, acrylic resin, polyurethane resin, polyester resin, polyvinyl acetate, polyvinyl chloride (PVC), polystyrene resin, polyacrylonitrile-butadiene-styrene resin, epoxy resin, and any mixture thereof.

The second material is any mixture selected from the group consisting of titanium dioxide powder, silica powder, aluminum oxide powder, metal oxide powder, pearl pearlescent powder, and any mixture thereof.

The image receiving layer comprises a third material and a fourth material.

The third material is any mixture selected from the group consisting of polyvinyl acetate, polyvinyl alcohol, polyvinylpyrrolidone, polyvinyl pyridine, maleic anhydride polymer and copolymers thereof, gelatin, animal glue, Arabic gum, polyacrylic acid and salts thereof, polyethylene oxide, polyethyleneimine, polydiallyldiethyl ammonium chloride, polydiallyldimethyl ammoniumchloride, diallyldialkyl ammonium polymer where the n in alkyl group CₙH₂ₙ₊₁ ranges from 1-4, cellulose, and any mixture thereof.

The fourth material is any mixture selected from the group consisting of titanium dioxide powder, polystyrene powder, polymethyl methacrylate powder, silica powder, aluminum oxide powder, metal oxide powder, pearl pearlescent powder, and any mixture thereof.

The base layer comprises a canvas, paper, a plastic film, a woven or a nonwoven article, or a chemical synthetic film.

The thickness of the stereoscopic oil relief layer ranges between 1 um and 80 mm.

The thickness of the image receiving layer ranges between 1 um and 100 um.

### BRIEF DESCRIPTION OF THE DRAWINGS

The invention can be more fully understood by reading the subsequent detailed description and examples with references made to the accompanying drawings, wherein:

FIG. 1 is a flowchart showing a method, for simulating, fabricating, or duplicating an oil painting, of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The following description is directed to a method for simulating, fabricating, or duplicating an oil painting.

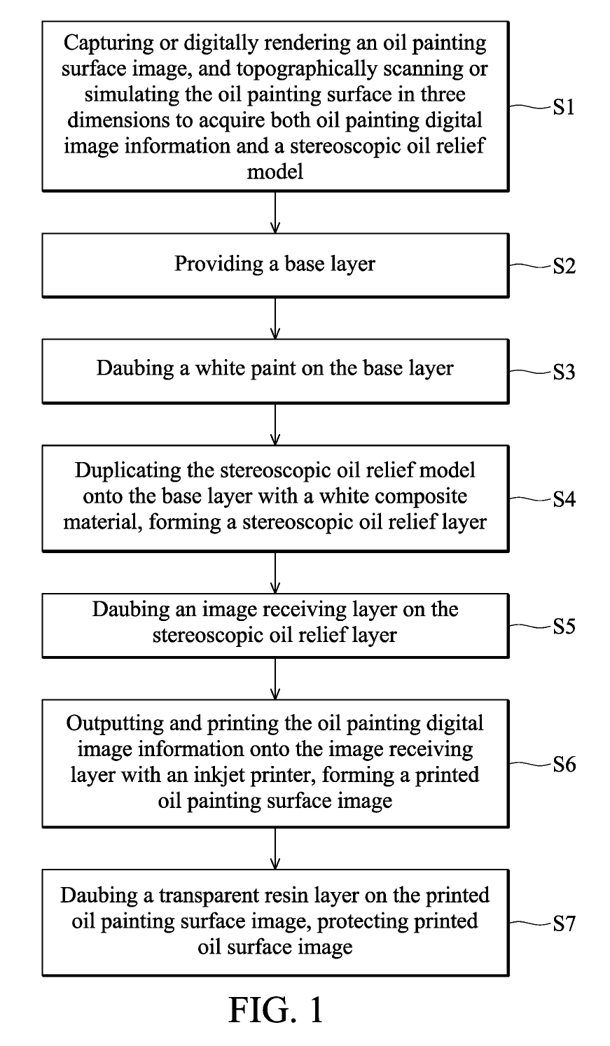

An oil painting surface image is captured or digitally rendered to obtain oil painting digital image information. Then, an oil surface of the primitive oil painting is topographically scanned in three dimensions to acquire a stereoscopic oil relief model, as shown by the step S1 of FIG. 1. Specifically, an operator or a duplicator can use a three-dimensional scanner to scan the oil painting surface image of the primitive oil painting, and the obtained stereoscopic oil relief model and oil painting digital image information can be stored.

Next, a base layer is provided, as shown by the step S2 of FIG. 1. Here, the base layer may comprise a canvas, paper, a plastic film, a woven article or a non-woven article, or a chemical synthetic film.

Next, a white paint is daubed on the base layer, as shown by the step S3 of FIG. 1. Here, the step of daubing the white paint on the base layer may be optional. Specifically, as most oil paintings are created on white canvases, oil colors can be clearly presented. Thus, when the base layer is not provided with a white ground, the white paint daubed thereon can help to achieve a compensation effect.

Next, the stereoscopic oil relief model is duplicated or simulated onto the base layer with a white composite material, forming a stereoscopic oil relief layer, as shown by the step S4 of FIG. 1. Specifically, according to the stored stereoscopic oil relief model scanned by the three-dimensional scanner, the operator or duplicator can manually apply the white composite material onto the base layer. More specifically, the operator or duplicator can engrave a corresponding intaglio, and print or transfer the white composite material onto the base layer by using the intaglio, thereby forming the stereoscopic oil relief layer, having stereoscopic oil reliefs of the primitive oil painting, on the base layer. Here, the thickness of the stereoscopic oil relief layer ranges between 1 um and 80 mm. Moreover, in this embodiment, the white composite material comprises a first material and a second material. The first material is selected from the group consisting of gypsum, clay, acrylic resin, polyurethane resin, polyester resin, polyvinyl acetate, polyvinyl chloride (PVC), polystyrene resin, polyacrylonitrile-butadiene-styrene resin, epoxy resin, and any mixture thereof, while the second material is any mixture selected from the group consisting of titanium dioxide powder, silica powder, aluminum oxide powder, metal oxide powder, pearl pearlescent powder, and any mixture thereof. Accordingly, as the first material is often transparent, the first material is mixed with the white second material to form the white composite material.

Next, an image receiving layer is daubed on the dried stereoscopic oil relief layer, as shown by the step S5 of FIG. 1. Here, the thickness of the image receiving layer ranges between 1 um and 100 um. Moreover, in this embodiment, the image receiving layer comprises a third material and a fourth material. The third material is any mixture selected from the group consisting of polyvinyl acetate, polyvinyl alcohol, polyvinylpyrrolidone, polyvinyl pyridine, maleic anhydride polymer and copolymers thereof, gelatin, animal glue, Arabic gum, polyacrylic acid and salts thereof, polyethylene oxide, polyethyleneimine, polydiallyldiethyl ammonium chloride, polydiallyldimethyl ammoniumchloride, diallyldialkyl ammonium polymer where the n in alkyl group CₙH₂ₙ₊₁ ranges from 1-4, cellulose, and any mixture thereof, or cellulose, while the fourth material is any mixture selected from the group consisting of titanium dioxide powder, polystyrene powder, polymethyl methacrylate powder, silica powder, aluminum oxide powder, metal oxide powder, pearl pearlescent powder, and any mixture thereof.

Next, after an alignment and registration process is performed, the stored oil painting digital image information is output and printed onto the dried image receiving layer with a high-definition inkjet printer, forming a printed oil painting surface image, as shown by the step S6 of FIG. 1. Here, the image receiving layer can enhance ink adsorption, wetting, absorption, and drying of colored inks output by the inkjet printer, enabling definition, resolution, color saturation, brightness, and contrast of the printed oil painting surface image to be equivalent to definition, resolution, color saturation, brightness, and contrast of the oil painting surface image of the primitive oil painting.

Finally, a transparent resin layer is daubed on the dried printed oil painting surface image, protecting the printed oil painting surface image, as shown by the step S7 of FIG. 1. Here, duplication of the primitive oil painting is complete.

Accordingly, in the disclosed method for simulating, fabricating, or duplicating the oil painting, the high-definition oil painting digital image information obtained by scanning, capturing, simulation, or rendering the primitive oil painting is printed on the image receiving layer covering the stereoscopic oil relief layer, perfectly integrating the oil colors, with drawing strokes, and oil reliefs together, and further generating a high-quality oil painting replica that looks realistic and almost the same as the primitive oil painting. Thus, the high-quality oil painting replica produced by the disclosed method can be vividly rendered to the public for viewing and appreciation.

While the invention has been described by ways of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for simulating, fabricating, or duplicating an oil painting, comprising:
scanning, capturing an oil painting surface image, or digitally simulating or rendering an image to acquire oil painting digital image information;
topographically scanning, or simulating an oil painting surface in three dimensions to acquire a stereoscopic oil relief model;
providing a base layer;
duplicating or simulating the stereoscopic oil relief model onto the base layer with a white or colorless transparent composite material, forming a stereoscopic oil relief layer;
daubing an image receiving layer on the stereoscopic oil relief layer; and
outputting and printing the oil painting digital image information onto the image receiving layer with an inkjet printer, forming a printed oil painting surface image.

2. The method as claimed in claim 1, further comprising daubing a white paint on the base layer.

3. The method as claimed in claim 1, further comprising daubing a transparent resin layer on the printed oil painting surface image, protecting the printed oil painting surface image.

4. The method as claimed in claim 1, wherein the white composite material comprises a first material and a second material.

5. The method as claimed in claim 4, wherein the first material is selected from the group consisting of gypsum, clay, acrylic resin, polyurethane resin, polyester resin, polyvinyl acetate, polyvinyl chloride (PVC), polystyrene resin, polyacrylonitrile-butadiene-styrene resin, epoxy resin, and any mixture thereof.

6. The method as claimed in claim 4, wherein the second material is any mixture selected from the group consisting of titanium dioxide powder, silica powder, aluminum oxide powder, metal oxide powder, pearl pearlescent powder, and any mixture thereof.

7. The method as claimed in claim 1, wherein the image receiving layer comprises a third material and a fourth material.

8. The method as claimed in claim 7, wherein the third material is any mixture selected from the group consisting of polyvinyl acetate, polyvinyl alcohol, polyvinylpyrrolidone, polyvinyl pyridine, maleic anhydride polymer and copolymers thereof, gelatin, animal glue, Arabic gum, polyacrylic acid and salts thereof, polyethylene oxide, polyethyleneimine, polydiallyldiethyl ammonium chloride, polydiallyldimethyl ammoniumchloride, diallyldialkyl ammonium polymer where the n in alkyl group CₙH₂ₙ₊₁ ranges from 1-4, cellulose, and any mixture thereof.

9. The method as claimed in claim 7, wherein the fourth material is any mixture selected from the group consisting of titanium dioxide powder, polystyrene powder, polymethyl methacrylate powder, silica powder, aluminum oxide powder, metal oxide powder, pearl pearlescent powder, and any mixture thereof.

10. The method as claimed in claim 1, wherein the base layer comprises a canvas, paper, a plastic film, a woven or a nonwoven article, or a chemical synthetic film.

11. The method as claimed in claim 1, wherein the thickness of the stereoscopic oil relief layer ranges between 1 um and 80 mm.

12. The method as claimed in claim 1, wherein the thickness of the image receiving layer ranges between 1 um and 100 um.
